(19) United States
(12) Patent Application Publication
(10) Pub. No.: US 2014/0074646 A1
(43) Pub. Date: Mar. 13, 2014

(54) Automated Negotiation

(71) Applicants: Mehmet Kivanc Ozonat, San Jose, CA (US); Sharad Singhal, Belmont, CA (US)

(72) Inventors: Mehmet Kivanc Ozonat, San Jose, CA (US); Sharad Singhal, Belmont, CA (US)

(21) Appl. No.: 14/003,275

(22) PCT Filed: May 31, 2011
(86) PCT No.: PCT/US11/38499

§ 371 Date: Sep. 5, 2013

(51) Int. Cl. G06Q 30/06

(52) U.S. Cl. CPC G06Q 30/0611
USPC 705/26.4

(57) ABSTRACT

Offers previously accepted and offers previously made by one or more opposing parties in negotiations inform an assessment of the likelihood that a candidate offer will be accepted by an opponent in a negotiation.

### BACKGROUND

Electronic commerce technologies enable consumers to purchase products and services from businesses online.

### BRIEF DESCRIPTION OF THE DRAWINGS

FIGS. 1A and 1B are schematic diagrams of an example user interface for interacting with an automated negotiation agent.

FIGS. 2A and 2B are schematic diagrams of examples of two-dimensional issue space negotiation models.

FIG. 3 is a block diagram of an example of a communications system.

FIGS. 4-5 are flowcharts of examples of processes for training classifiers to classify candidate offers according to their likelihood of being accepted.

FIGS. 6-7 are flowcharts of examples of processes for identifying an offer to present to an opponent in a negotiation.

### DETAILED DESCRIPTION

An automated negotiation agent conducts negotiations with human counterparts or other automated negotiation agents. During such an automated negotiation, the automated negotiation agent may assess the likelihood that its opponent will accept an offer before proposing the offer to its opponent. For example, the automated negotiation agent may apply a candidate offer to a classifier before proposing the candidate offer to its opponent. If the classifier determines that the candidate offer is an offer that the automated negotiation agent's opponent is likely to accept, the automated negotiation agent may propose the offer to its opponent. In contrast, if the classifier determines that the candidate offer is an offer that the automated negotiation agent's opponent is unlikely to accept, the automated negotiation agent may decide against proposing the offer to its opponent, preferring instead to identify an alternative offer that the automated negotiation agent's opponent may be more likely to accept. The classifier may be trained using data from past negotiations and/or the present negotiation reflecting offers that one or more opposing parties found acceptable (e.g., offers that were accepted by opposing parties in past negotiations and/or offers that were made by opposing parties in past negotiations and/or the present negotiation).

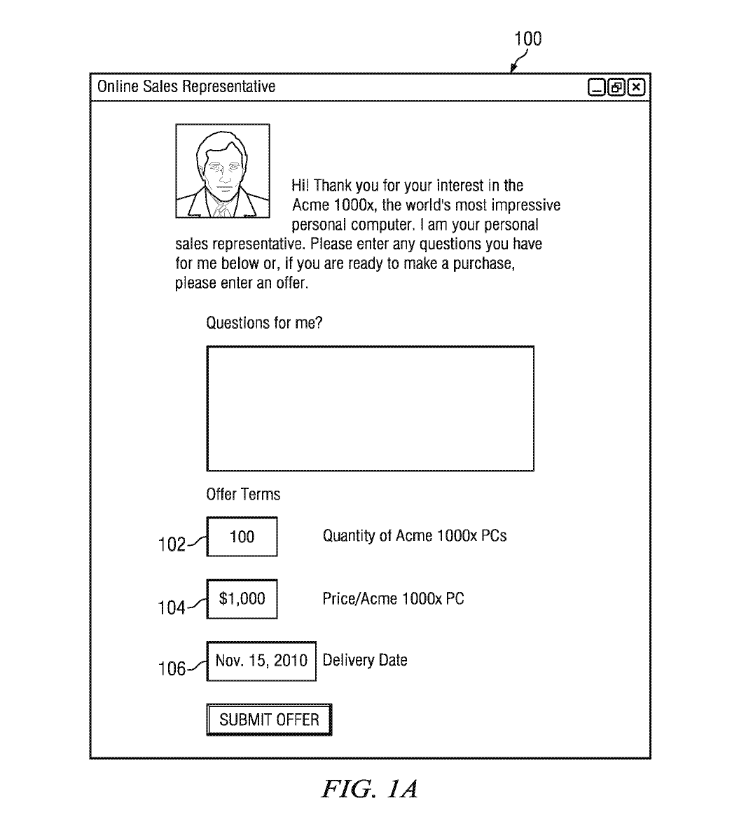

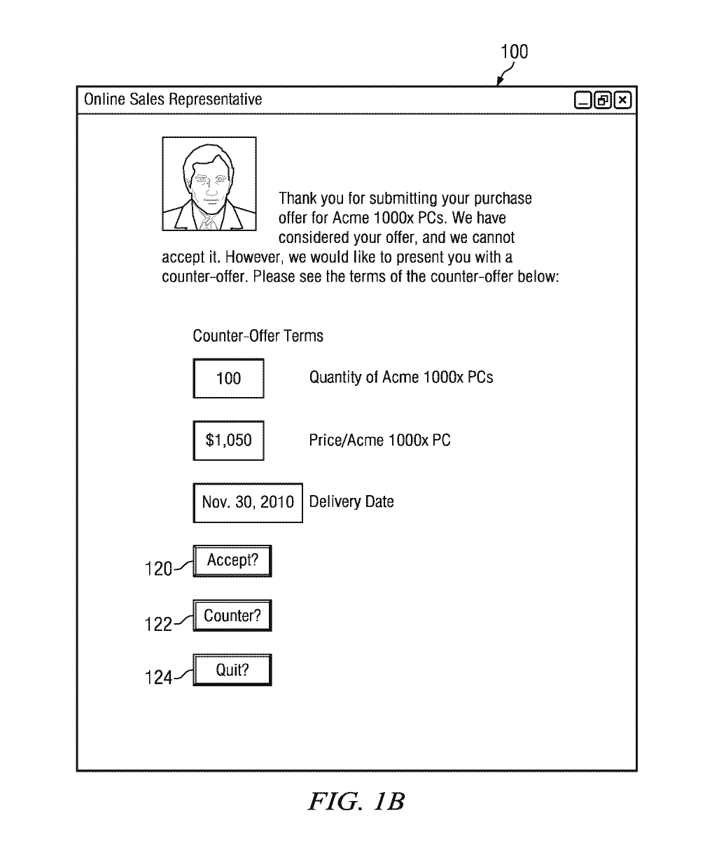

FIGS. 1A and 1B are schematic diagrams of an example user interface 100 for interacting with an automated negotiation agent. The automated negotiation agent, which may be implemented as one or more applications executing on one or more servers or other computing devices, is configured to engage, on behalf of a party (e.g., a business), in a negotiation over different issues of a transaction with a human counterpart. For example, the automated negotiation agent may be able to receive and evaluate offers submitted by a human counterpart, enabling the automated negotiation agent and the human counterpart to engage in a back and forth exchange of offer and counteroffer until the automated agent and the human counterpart are able to agree upon terms of the transaction or until one party decides to terminate the negotiation.

As illustrated in FIGS. 1A and 1B, the automated negotiation agent is configured to negotiate the terms of the sale of one or more personal computers with a human counterpart, and the user interface 100 enables a user to submit terms of an initial offer to the automated agent. In particular, the user interface 100 includes a quantity field 102, a unit price field 104, and a delivery date field 106 that enable the human counterpart to propose a quantity of personal computers to be purchased, a unit price for each personal computer, and a delivery date, respectively, as the terms of an initial offer. As illustrated in FIG. 1A, the human counterpart has proposed to purchase 100 personal computers at a purchase price of $1,000 per personal computer, with a delivery date for the personal computers of Nov. 15, 2010.

In response to receiving the terms proposed by the human counterpart, the automated negotiation agent considers the terms proposed by the human counterpart and determines if the terms are acceptable to the party on behalf of whom the automated negotiation agent is negotiating. In the event that the automated negotiation agent determines that the terms proposed by the human counterpart are not acceptable to the party that the automated negotiation agent is representing, the automated negotiation agent may determine to make a counteroffer to the human counterpart with terms that are acceptable to the party that the automated negotiation agent is representing. As will be described in greater detail below, the automated negotiation agent may use a classifier to assess the likelihood that the human counterpart will accept a particular candidate counteroffer before proposing the candidate counteroffer to the human counterpart.

As illustrated in FIG. 1B, the automated negotiation agent decided that the human counterpart's initial proposal to purchase 100 personal computers at a purchase price of $1,000 per personal computer with a delivery date of Nov. 15, 2010 is not acceptable and, therefore, proposed a counteroffer with terms acceptable to the party on behalf of whom the automated negotiation agent is negotiating. In particular, the automated negotiation agent counter-offered by proposing an increased unit purchase price of $1,050 per personal computer and a delayed delivery date of Nov. 30, 2010 for the same quantity of 100 personal computers. Before proposing this counteroffer to the human counterpart, the automated negotiation agent may have applied the terms of the counteroffer to a classifier and determined that the counteroffer is likely to be accepted by the human counterpart.

As further illustrated in FIG. 1B, in addition to presenting the terms of the automated negotiation agent's counteroffer to the human counterpart, the interface 100 also provides a selectable control 120 that enables the human counterpart to accept the automated negotiation agent's counteroffer and consummate the transaction, a selectable control 122 that enables the human counterpart to propose a counteroffer to the automated negotiation agent's offer, and a selectable control 124 that enables the human counterpart to terminate the negotiation.

Should the human counterpart decide to propose a counteroffer to the automated negotiation agent's offer by selecting selectable control 122, the human counterpart and the automated negotiation agent can continue the negotiation, going back and further exchanging offers and counteroffers, until the human counterpart and the automated negotiation agent arrive at mutually agreeable terms or until one party decides to terminate the negotiation.

A negotiation involving D different issues may be modeled in a D-dimensional issue space in which points within the D-dimensional issue space represent different possible combinations of terms for the D issues involved in the negotiation. In order to facilitate an efficient negotiation, an automated negotiation agent may attempt to infer the boundary within the D-dimensional issue space that separates offers that an opponent is likely to accept from offers that an opponent is unlikely to accept. That is to say, the automated negotiation agent may attempt to identify its opponent's decision threshold.

In order to identify such a decision threshold for a particular type of negotiation involving D different issues, data from previous negotiations of the same type and involving the same D issues may be tracked and, thereafter, accessed to build a model reflecting offers that opposing parties previously have found acceptable and offers that opposing parties previously have found unacceptable by mapping the offers opposing parties found acceptable and unacceptable to points within the D-dimensional issue space. Furthermore, in some implementations, multiple different models for the type of and issues involved in a negotiation may be created such that each model corresponds to a different class of potential opponents. In such implementations, the automated negotiation agent may identify the class of opponents within which the current opponent falls, identify model corresponding to that class of opponent, and use the corresponding model to inform the automated negotiation agent's negotiation strategy.

In building such a model, offers that opposing parties previously accepted and offers that opposing parties proposed themselves may be considered to be offers that opposing parties found acceptable. Similarly, offers that opposing parties rejected may be considered to be offers that opposing parties found unacceptable. In some implementations, the model may be updated in real-time in the middle of an on-going negotiation to reflect offers that the opponent in the current negotiation has found unacceptable. Furthermore, in some cases, multiple negotiations with different opponents may be conducted concurrently and the model may be updated in real-time in the middle of the negotiations to reflect offers that the different opponents in the concurrent negotiations have found unacceptable.

In the D-dimensional model, a boundary between offers opposing parties found acceptable and offers opposing parties found unacceptable may be identified and considered to represent an opponent's decision threshold. The boundary, thus, effectively defines, within the D-dimensional issue space, a first region that includes offers that were acceptable to opposing parties and a second region that includes offers that were unacceptable to opposing parties. As such, the boundary may be used to assess the likelihood that an opponent in a current negotiation will accept a candidate offer being considered for proposal by the automated negotiation agent.

For example, if a candidate offer being considered for proposal in a current negotiation falls within the first region of the D-dimensional issue space defined by the boundary that includes offers that were acceptable to opposing parties, the automated negotiation agent may infer that the candidate offer likely will be accepted by the opposing party. Likewise, if the candidate offer falls within the second region of the D-dimensional issue space defined by the boundary that includes offers that were unacceptable to opposing parties, the automated negotiation agent may infer that the candidate offer likely will not be accepted by the opposing party. Different techniques may be employed to identify the boundary in the D-dimensional issue space between offers an opponent is likely to accept and offers an opponent is unlikely to accept. For example, a support vector machine algorithm may be employed to identify the boundary. In some implementations, such as, for example when a support vector machine algorithm is used to identify the boundary, a linear or planar boundary may be defined. In other implementations, a non-linear or non-planar boundary may be defined.

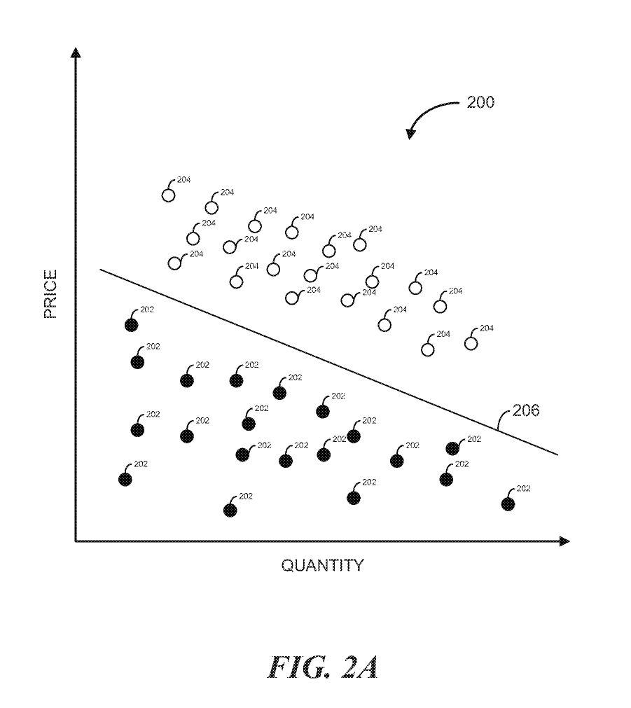

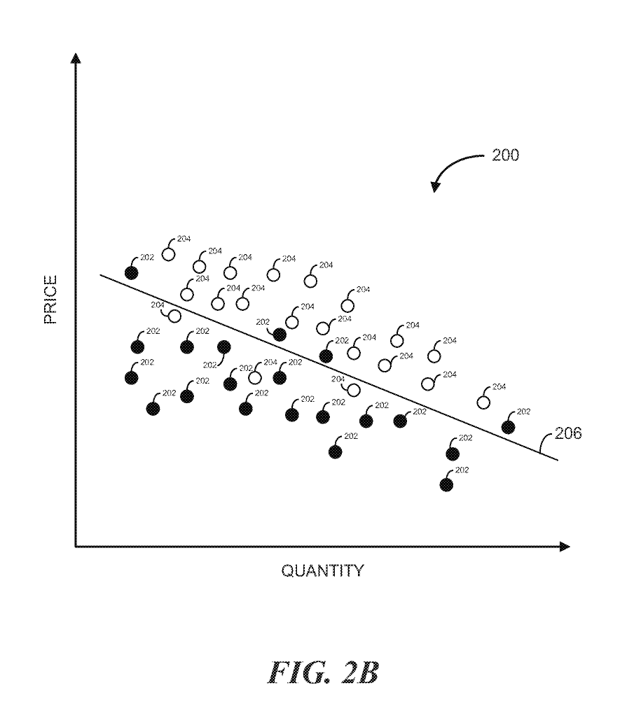

Referring to FIG. 2A, an example negotiation over the sale of some type of good involving the two issues of quantity and price may be modeled in a two-dimensional issue space 200. In FIG. 2A, filled circles 202 represent offers found to be acceptable by opposing parties (e.g., offers actually accepted by opposing parties and/or offers previously tendered by opposing parties) and empty circles 204 represent offers found to be unacceptable by opposing parties. In the example of FIG. 2A, given the positioning of the offers found to be acceptable by opposing parties 202 and the offers found to be unacceptable by opposing parties 204, a linear boundary 206 between offers found to be acceptable by opposing parties 202 and offers found to be unacceptable by opposing parties 204 may be readily identified. In other cases, however, it may not be as easy or even possible to identify a linear boundary between offers found to be acceptable by opposing parties and offers found to be unacceptable by opposing parties.

For example, referring to FIG. 2B, in which a second example negotiation is modeled in the two-dimensional issue space 200 and in which filled circles 202 again represent offers found to be acceptable by opposing parties and empty circles 204 again represent offers found to be unacceptable by opposing parties, there is no clear linear boundary between offers found to be acceptable by opposing parties 202 and offers found to be unacceptable by opposing parties 204. In such cases, an approximate linear boundary 206 between offers found to be acceptable by opposing parties 202 and offers found to be unacceptable by opposing parties 204 may be identified instead.

Although the examples of FIGS. 2A and 2B illustrate negotiations involving two issues modeled in two-dimensional issue spaces, a negotiation may involve any number of different issues and may be modeled in an issue space of any number of dimensions, and a boundary between offers found to be acceptable by opposing parties and offers found to be unacceptable to opposing parties still may be identified.

The task of identifying a planar boundary between offers found to be acceptable by opposing parties and offers found to be unacceptable to opposing parties in any given type of negotiation involving any number of issues D may be framed generally as follows. Given a set of training samples aᵢ, a₂, . . . , a_{N} (i.e., offers found either to be acceptable or unacceptable to opposing parties), each of which is a D-element real-valued vector, let bᵢ≦i≦N, represent an opposing party's preference for the corresponding offer aᵢ, where bᵢ=1 if the opposing party finds offer aᵢ acceptable and bᵢ=−1 if the opposing party finds offer a, unacceptable. The goal, then, is to find a hyperplane that divides the points a, having bᵢ=1 from the points aᵢ having bᵢ=−1.

A D-dimensional hyperplane generally can be defined as the set of points a (e.g., D-element vectors) satisfying:

w·a−p=0 (Eq. 1)

where the operator · represents the dot product, w is a D-element normal vector to the hyperplane, and

$$\frac{p}{‖ w ‖}$$

represents the offset of the hyperplane from the origin along the normal vector w. Thus, the goal is to choose w and p to find the two parallel hyperplanes

w·a−p=1 (Eq. 2)

and

w·a−p=−1 (Eq. 3)

that divide the points aᵢ having bᵢ=1 from the points aᵢ having bᵢ=−1 that are separated by the greatest distance. This can be achieved by finding the D-element vector w and the scalar p that minimize:

$$\frac{1}{2} ‖ {w}^{2} ‖ , \qquad ( Eq . 4 )$$

subject to the constraint that:

bᵢ(w·aᵢ−p)≧1 (Eq. 5)

for all i=1, 2, . . . , N.

Quadratic programming techniques may be used to solve the optimization problem set out in Equations 4-5. However, because, in some cases, there may not be a hyperplane that divides the points aᵢ having bᵢ=1 from the points aᵢ having bᵢ=−1 (e.g., as illustrated in the example of FIG. 2B), it may not always be possible to solve the optimization problem set out in Equations 4-5.

In such cases, an approximate solution may be found instead, with the problem being reformulated as finding the D-element vector w and the scalar p that minimize:

$$\{ \begin{matrix}\frac{1}{2} ‖ {w}^{2} ‖ & if {b}_{i} ( w \cdot {a}_{i} - p ) \geq 1 \\ \frac{1}{2} ‖ {w}^{2} ‖ + λ \vert {b}_{i} ( w \cdot {a}_{i} - p ) \vert & otherwise\end{matrix} \qquad ( Eq . 6 )$$

where λ is a penalty term applied to training samples that are misclassified by the resultant hyperplane. After a boundary between a first region that includes offers that are perceived as being likely to be accepted by an opposing party and a second region that includes offers that are perceived as being unlikely to be accepted by an opposing party has been identified (e.g., a hyperplane as described above), an automated negotiation agent may use the boundary to inform its negotiation strategy with an opponent.

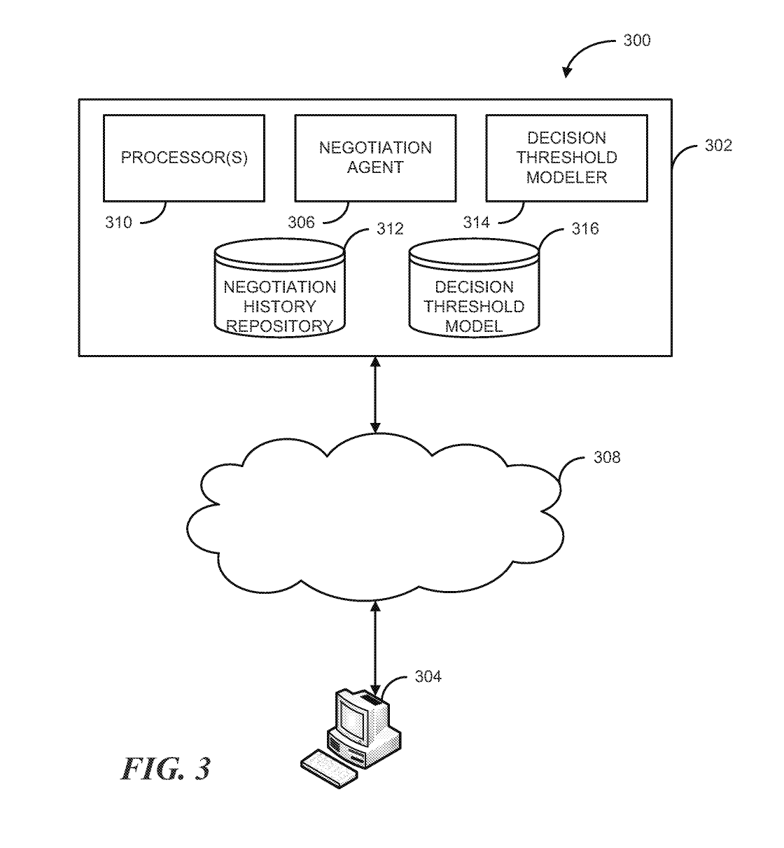

FIG. 3 is a block diagram of an example of a communications system 300, including an electronic commerce complex 302, a client computer 304, and a network 308 that enables a human user of client computer 304 to engage in automated negotiations with an automated negotiation agent 306 executing on electronic commerce complex 302. For illustrative purposes, several elements illustrated in FIG. 3 and described below are represented as monolithic entities. However, these elements each may include and/or be implemented on numerous interconnected computing devices and other components that are designed to perform a set of specified operations and that are located proximally to one another or that are geographically displaced from one another.

As illustrated in FIG. 3, the electronic commerce complex 302 and automated negotiation agent 306 are accessible to client computer 304 over network 308.

Client computer 304 may be any of a number of different types of computing devices including, for example, a personal computer, a special purpose computer, a general purpose computer, a combination of a special purpose and a general purpose computing device, a laptop computer, a tablet computer, a netbook computer, a smart phone, a mobile phone, a personal digital assistant, and a portable media player. Client computer 304 typically has internal or external storage components for storing data and programs such as an operating system and one or more application programs. For example, the internal or external storage components for client computer 304 may store a dedicated client application for interfacing with electronic commerce complex 302 and/or automated negotiation agent 306. Alternatively, in some implementations, client computer 304 may interface with electronic commerce complex 302 and automated negotiation agent 306 without a specific client application (e.g., using a web browser).

Client computer 304 also typically includes a central processing unit (CPU) for executing instructions stored in storage and/or received from one or more other electronic devices, for example over network 308. In addition, client computer 304 also usually includes one or more communications devices for sending and receiving data. One example of such a communications device is a modem. Other examples include an antenna, a transceiver, a communications card, and other types of network adapters capable of transmitting and receiving data over network 308 through a wired or wireless data pathway.

Electronic commerce complex 302 may be implemented using one or more computing devices (e.g., servers) configured to provide a service to one or more client devices (e.g., client computer 304) connected to electronic commerce complex 302 over network 308. The one or more computing devices on which electronic commerce complex 302 is implemented may have internal or external storage components storing data and programs such as an operating system and one or more application programs. The one or more application programs may be implemented as instructions that are stored in the storage components and that, when executed, cause the one or more computing devices to provide the features of the electronic commerce complex 302 and/or automated negotiation agent 306 described herein.

Furthermore, the one or more computing devices on which electronic commerce complex 302 is implemented each may include one or more processors 310 for executing instructions stored in storage and/or received from one or more other electronic devices, for example over network 308. In addition, these computing devices also typically include network interfaces and communication devices for sending and receiving data.

Network 308 may provide direct or indirect communication links between electronic commerce complex 302 and client computer 304 irrespective of physical separation between any of such devices. As such, electronic commerce complex 302 and client computer 304 may be located in close geographic proximity to one another or, alternatively, electronic commerce complex 302 and client computer 304 may be separated by vast geographic distances. Examples of network 308 include the Internet, the World Wide Web, wide area networks (WANs), local area networks (LANs) including wireless LANs (WLANs), analog or digital wired and wireless telephone networks, radio, television, cable, satellite, and/or any other delivery mechanisms for carrying data. In some implementations, client computer 304 may be connected to network 308 over a wireless connection (e.g., a WLAN based on the IEEE 802.11 standard, a radio frequency-based wireless network, and/or a cellular or mobile telephony network provided by a wireless service provider) made available by a private service provider.

As illustrated in FIG. 3, electronic commerce complex 302 includes a computer memory storage system 312 storing data about previous negotiations that were conducted with opposing parties and/or any current negotiations being conducted with opposing parties. For example, the negotiation history repository stored in computer memory storage system 312 may include records of the offers and counteroffers made as previous negotiations progressed through rounds of negotiations as well as information about offers that ultimately were accepted by both sides. As negotiations unfold, electronic commerce complex system 302 may track offers and counteroffers made in the negotiations and store such information in the negotiation history repository of computer memory storage system 312.

Electronic commerce complex 302 also includes a decision threshold modeler 314 that is configured to access the negotiation history repository stored in computer memory storage system 312 and build, based on the records stored in the negotiation history repository, one or more models of opponents' decision thresholds that identify boundaries between offers an opponent is likely to accept and offers that an opponent is likely to reject. Decision threshold modeler 314 may be implemented as instructions stored in a computer memory storage system that, when executed, cause processor(s) 310 to provide the functionality ascribed herein to the decision threshold modeler 314. The decision threshold model(s) generated by decision threshold modeler 314 are stored in computer memory storage system 316, from which they are available to negotiation agent 306.

Electronic commerce complex 302 may provide a catalog or other collection of products or services that are available for sale from a business, and a human user of client computer 304 may be able to access and browse such a catalog or other collection of products or services for sale over network 308. In the event that, through the course of browsing the catalog or other collection of products or services that are available for sale, a human user of client computer 304 locates a product or service that the human user is interested in purchasing, the human user may use client computer 304 to communicate that interest to electronic commerce complex 302. In response, automated negotiation agent 306 then may engage the human user of client computer 304 in an automated negotiation over the terms of the transaction, during the course of which the automated negotiation agent 306 and the human user of client computer 304 present offers and counteroffers to one another by exchanging electronic messages over network 308.

While conducting an automated negotiation with a human user of client computer 304, negotiation agent 306 may access a decision threshold model from computer memory storage system 316 and use the accessed decision threshold model to assess the likelihood that the human user of client computer 304 will accept a candidate offer that the automated negotiation agent 306 is contemplating proposing. In this manner, the automated negotiation agent 306 may use the decision threshold model to identify offers to the human user of client computer 304 that the automated negotiation agent 306 believes the human user of client computer 304 is likely to accept and that are advantageous to the party on behalf of whom the automated negotiation agent 306 is negotiating.

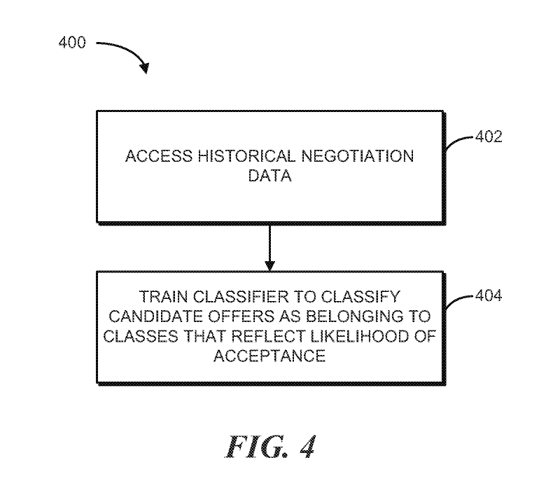

FIG. 4 is a flowchart 400 illustrating an example of a process for training a classifier to classify candidate offers according to their likelihood of being accepted in the context of a negotiation involving a particular type of transaction and a particular set of issues. The process illustrated in the flowchart 400 of FIG. 4 may be performed by an electronic commerce system such as the electronic commerce complex 302 illustrated in FIG. 3. More specifically, the process illustrated in the flowchart 400 of FIG. 4 may be performed by one or more of the processors 310 of the computing device(s) that implement the electronic commerce complex 302 under control of automated negotiation agent 306 and/or decision threshold modeler 314.

At 402, historical negotiation data is accessed. For example, decision threshold modeler 314 may access data from previous negotiations and/or one or more ongoing negotiations involving the same particular type of transaction and the same particular set of issues about offers that were made by opposing parties, offers that were accepted by opposing parties, and offers that were rejected by opposing parties. In some implementations, this data may have been tracked and stored by the electronic commerce complex 302 in negotiation history repository of computer memory storage system 312 as negotiations played out. In other implementations, this data may be available to decision threshold modeler 314 by some other data source. Offers that were made by opposing parties and offers that were accepted by opposing parties both may be considered to represent offers that were considered acceptable by opposing parties. In contrast, offers that were rejected by opposing parties may be considered to represent offers that were considered unacceptable by opposing parties.

At step 404, the accessed historical negotiation data is used to train a classifier to classify candidate offers as belonging to classes that reflect the likelihood that the offers will be accepted by an opponent. For example, decision threshold modeler 314 may use the accessed historical negotiation data to train a classifier to classify candidate offers as belonging either to a first class of offers that are likely to be accepted by an opponent or a second class of offers that are unlikely to be accepted by an opponent. In some implementations, this may be accomplished by using the accessed historical negotiation data to identify a boundary in the issue space between offers that opposing parties previously found acceptable and offers that opposing parties previously found unacceptable and then determining on which side of the boundary a candidate offer falls. The trained classifier then may be stored as a decision threshold model in computer memory storage system 316.

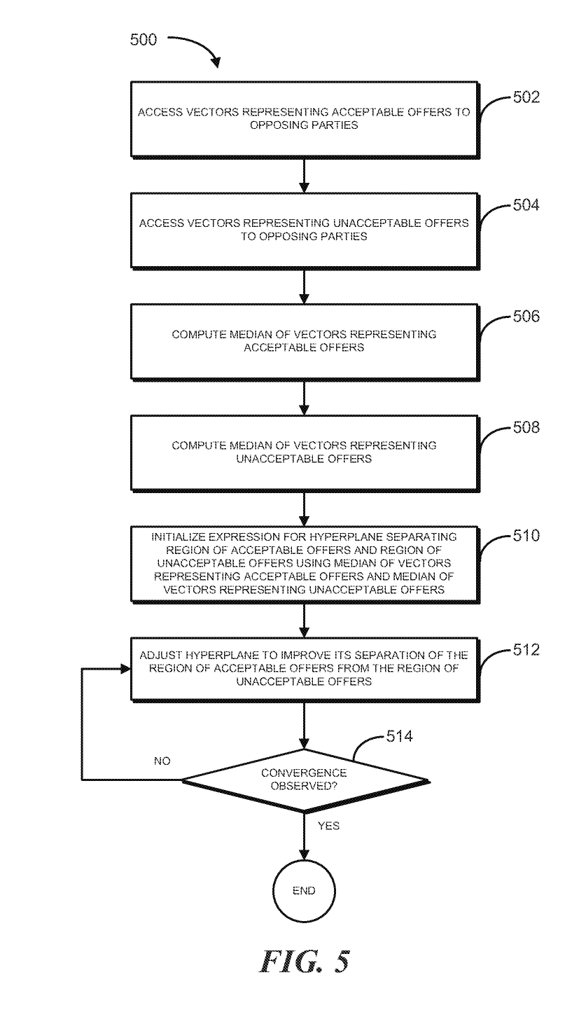

FIG. 5 is a flowchart 500 illustrating an example of a process for training a classifier to classify candidate offers according to their likelihood of being accepted in the context of a negotiation involving a particular type of transaction and a particular set of issues. The process illustrated in the flowchart 500 of FIG. 5 may be performed by an electronic commerce system such as the electronic commerce complex 302 illustrated in FIG. 3. More specifically, the process illustrated in the flowchart 500 of FIG. 5 may be performed by one or more of the processors 310 of the computing device(s) that implement the electronic commerce complex 302 under control of automated negotiation agent 306 and/or decision threshold modeler 314. In the context of FIG. 5, the negotiation may involve some number D≧2 issues defining a D-dimensional issue space.

At 502, D-element vectors that represent acceptable offers to opposing parties are accessed, where the individual elements of any vector represent terms for the issues to which they correspond that were proposed as part of the acceptable offer. For example, decision threshold modeler 314 may access D-element vectors representing offers that previously were made by one or more opposing parties and/or offers that previously were accepted by one or more opposing parties from the negotiation history repository stored in computer memory storage system 312.

At 504, D-element vectors that represent unacceptable offers to opposing parties are accessed, where the individual elements of any vector represent terms for the issues to which they correspond that were proposed as part of the unacceptable offer. For example, decision threshold modeler 314 may access D-element vectors representing offers that previously were rejected by one or more opposing parties from the negotiation history repository stored in computer memory storage system 312.

At 506, the median of the vectors representing acceptable offers is computed and, at 508, the median of the vectors representing unacceptable offers is computed. Then, at 510, an expression for a hyperplane in the D-dimensional issue space that divides a region of acceptable offers and a region of unacceptable offers is initialized using the computed median of the vectors representing acceptable offers and the computed median of the vectors representing unacceptable offers. For example, decision threshold modeler 314 may initialize the general expression for a hyperplane given in Equation 7:

w·a−p=0 (Eq. 7)

by setting w⁰, an initial value for w, and p⁰, an initial value for p, to:

$$\begin{matrix}{w}^{0} = \frac{1}{2} ( {m}_{1} + {m}_{2} ) \\ and & ( Eq . 8 ) \\ {p}^{0} = \frac{1}{2} {w}^{0} {\dot{m}}_{1} + {w}^{0} {\dot{m}}_{2} , & ( Eq . 9 )\end{matrix}$$

where m₁ is the computed median of vectors representing acceptable offers and m₂ is the computed median of vectors representing unacceptable offers.

At 512, the expression of the hyperplane initialized according to Equations 8-9 is adjusted to improve the hyperplane's separation of the region of acceptable offers from the region of unacceptable offers in the D-dimensional issue space. For example, decision threshold modeler 314 may define a set of D-dimensional increment vectors δ, where each increment vector δ₁, specifies different incremental adjustments to be made to m₁ and m₂, and, for each increment vector δₖ, w may be set to:

w=w⁰+δₖ, (Eq. 10)

for the purposes of evaluating Equation 6. Then, wⁱ may be set to the value of w that minimizes Equation 6 over all of the increment vectors δ, and pⁱ may be set to:

$${p}^{i} = \frac{1}{2} {w}^{i} {\dot{m}}_{1} + {w}^{i} {\dot{m}}_{2}$$

Then, at 514, a determination of whether a convergence has been observed in the minimized value of Equation 6 may be made. For example, the current minimized value of Equation 6 may be compared to the minimized value of Equation 6 from the previous iteration, and, if the change in the minimized value of Equation 6 between the two iterations is less than a predetermined threshold value, a determination may be made that the solution has converged. In contrast, if the change in the minimized value of Equation 6 between the two iterations is more than the predetermined threshold value, a determination may be made that the solution has not yet converged.

If no convergence is observed at 514, the process may return to 512 where may be set to i=i+1 and the hyperplane again may be adjusted as described above to further improve its separation of the region of acceptable offers from the region of unacceptable offers. In contrast, if a convergence is observed at 516, the process may stop with the current expression for the hyperplane being determined to be sufficiently trained for use classifying candidate offers as being likely to be accepted by an opponent party or unlikely to be accepted by an opponent.

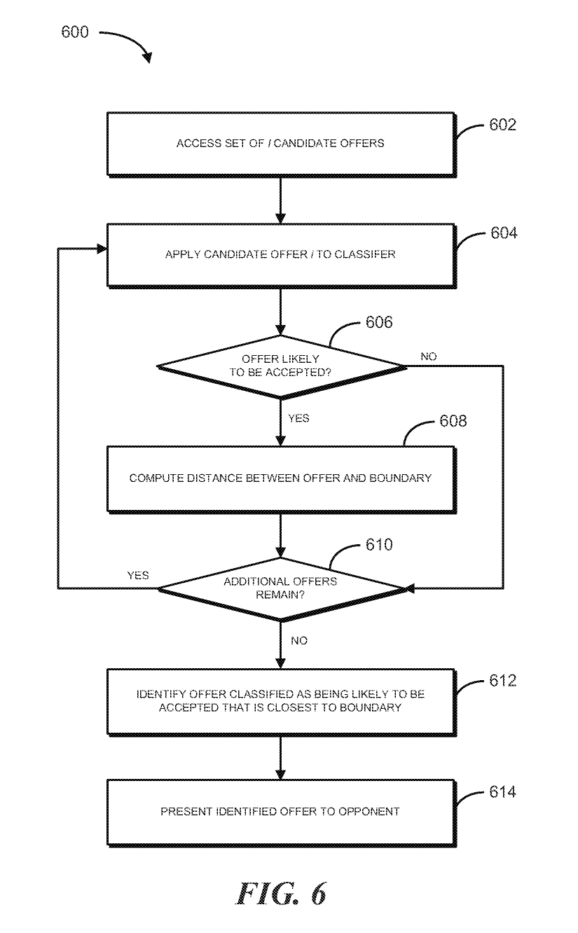

FIG. 6 is a flowchart of an example of a process for identifying an offer to present to an opponent in a negotiation. More particularly, FIG. 6 is a flowchart of an example of a process for using a classifier trained (e.g., according to the example process illustrated and described in connection with FIG. 4 and/or the example process illustrated and described in connection with FIG. 5) to classify candidate offers according to their likelihood of acceptance to identify an offer to present to an opponent in a negotiation. The process illustrated in the flowchart 600 of FIG. 6 may be performed by an electronic commerce system such as the electronic commerce complex 302 illustrated in FIG. 3. More specifically, the process illustrated in the flowchart 600 of FIG. 6 may be performed by one or more of the processors 310 of the computing device(s) that implement the electronic commerce complex 302 under control of automated negotiation agent 306.

At 602, a set of I Candidate offers is accessed. For example, automated negotiation agent 306 may access a set of candidate offers determined to be acceptable to the party on behalf of whom automated negotiation agent 306 is negotiating. In some cases, the automated negotiation agent 306 may access the set of candidate offers after having received an offer from an opponent and having determined that the received offer was unacceptable to the party on behalf of whom the automated negotiation agent 306 is negotiating. In such cases, the automated negotiation agent 306 may access the set of candidate offers and perform the other operations of the process illustrated in the flowchart 600 of FIG. 6 as part of identifying a counteroffer to present to the opponent in response to rejecting the offer previously received from the opponent.

At 604, an individual candidate offer i from the set of accessed candidate offers is applied to a classifier configured to classify offers into a first class of offers that are perceived as being likely to be accepted by an opponent and a second class of offers that are perceived as being unlikely to be accepted by an opponent. For example, automated negotiation agent 306 may apply candidate offer i to a decision threshold model stored in computer memory storage system 316. In some implementations, the decision threshold model may be a hyperplane in the D-dimensional issue space of the negotiation that was trained to classify candidate offers as being either likely to be accepted by an opponent or unlikely to be accepted by an opponent by defining the hyperplane as separating a first region in the D-dimensional issue space that includes offers previously deemed acceptable by opposing parties from a second region in the D-dimensional issue space that includes offers previously deemed unacceptable by opposing parties according to the example process illustrated and described above in connection with FIG. 5.

At 606, a determination is made as to whether the candidate offer i was classified as belonging to the first class of offers that are perceived as being likely to be accepted by an opponent or the second class of offers that are perceived as being unlikely to be accepted by an opponent. For instance, continuing with the example introduced above, if the classifier is a hyperplane in the D-dimensional issue space of the negotiation that classifies candidate offers as being either likely to be accepted by an opponent or unlikely to be accepted by an opponent, the automated negotiation agent 306 may determine that the candidate offer i is likely to be accepted by an opponent if application of the candidate offer i to the expression for the hyperplane demonstrates that the candidate offer/falls within the region in the D-dimensional issue space that is on the side of the hyperplane that corresponds to offers that an opponent is perceived as being likely to accept. In contrast, if application of the candidate offer i to the expression for the hyperplane demonstrates that the candidate offer i falls within the region in the D-dimensional issue space that is on the side of the hyperplane that corresponds to offers that an opponent is perceived as being unlikely to accept, the automated negotiation agent 306 may determine that the candidate offer i is unlikely to be accepted by an opponent.

In the event that the classifier classified candidate offer i as being an offer that is likely to be accepted by an opponent, at 608, the distance in the issue space of the negotiation is computed between the offer and the boundary between the first region of offers likely to be accepted and the second region of offers unlikely to be accepted as defined by the classifier. For example, if the classifier is a hyperplane in the D-dimensional issue space of the negotiation that classifies candidate offers as being either likely to be accepted by an opponent or unlikely to be accepted by an opponent, the automated negotiation agent 306 may calculate the distance in the issue space between the candidate offer i and the hyperplane.

At 610, a determination is made as to whether additional candidate offers remain in the set of I Candidate offers or whether all of the candidate offers in the set of I candidate offers have been considered. If additional candidate offers remain in the set of I candidate offers, the process returns to 604, where another candidate offer is applied to the classifier.

In contrast, if no additional candidate offers remain in the set of I candidate offers, the process proceeds to 612, where the individual candidate offer from among the candidate offers classified as being likely to be accepted that is closest to the boundary between the first region of offers likely to be accepted and the second region of offers unlikely to be accepted as defined by the classifier is identified. This offer then is presented to the opponent at 614.

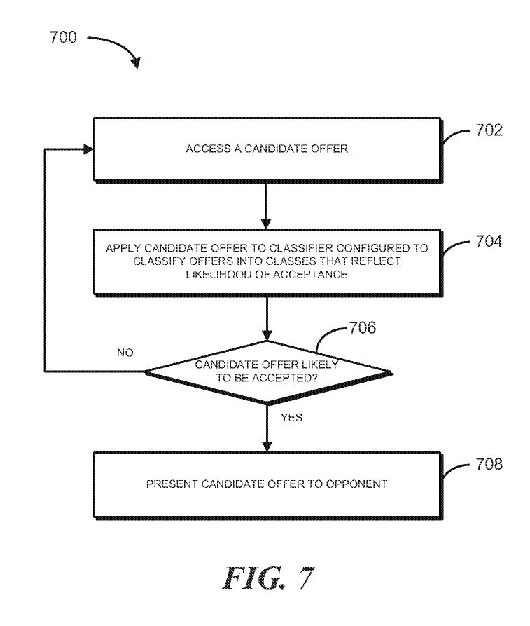

FIG. 7 is a flowchart of another example of a process for identifying an offer to present to an opponent in a negotiation. More particularly, FIG. 7 is a flowchart of an example of a process for using a classifier trained (e.g., according to the example process illustrated and described in connection with FIG. 4 and/or the example process illustrated and described in connection with FIG. 5) to classify candidate offers according to their likelihood of acceptance to identify an offer to present to an opponent in a negotiation. The process illustrated in the flowchart 700 of FIG. 7 may be performed by an electronic commerce system such as the electronic commerce complex 302 illustrated in FIG. 3. More specifically, the process illustrated in the flowchart 700 of FIG. 7 may be performed by one or more of the processors 310 of the computing device(s) that implement the electronic commerce complex 302 under control of automated negotiation agent 306.

At 702, a candidate offer is accessed. For example, automated negotiation agent 306 may access a candidate offer from a set of candidate offers determined to be acceptable to the party on behalf of whom automated negotiation agent 306 is negotiating. In some cases, the automated negotiation agent 306 may access the candidate offer after having received an offer from an opponent and having determined that the received offer was unacceptable to the party on behalf of whom the automated negotiation agent 306 is negotiating. In such cases, the automated negotiation agent 306 may access the candidate offer and perform the other operations of the process illustrated in the flowchart 700 of FIG. 7 as part of identifying a counteroffer to present to the opponent in response to rejecting the offer previously received from the opponent.

At 704, the accessed candidate offer is applied to a classifier configured to classify offers into classes that reflect their likelihood of acceptance. For example, automated negotiation agent 306 may apply the accessed offer to a decision threshold model stored in computer memory storage system 316. In some implementations, the decision threshold model may be a hyperplane in the D-dimensional issue space of the negotiation that was trained to classify candidate offers as being either likely to be accepted by an opponent or unlikely to be accepted by an opponent by defining the hyperplane as separating a first region in the D-dimensional issue space that includes offers previously deemed acceptable by opposing parties from a second region in the D-dimensional issue space that includes offers previously deemed unacceptable by opposing parties according to the example process illustrated and described above in connection with FIG. 5.

At 706, a determination of how likely the candidate offer is to be accepted is made based upon the result of having applied the candidate offer to the classifier. For instance, continuing with the example introduced above, if the classifier is a hyperplane in the D-dimensional issue space of the negotiation that classifies candidate offers as being either likely to be accepted by an opponent or unlikely to be accepted by an opponent, the automated negotiation agent 306 may determine that the candidate offer is likely to be accepted by an opponent if application of the candidate offer to the expression for the hyperplane demonstrates that the offer falls within the region in the D-dimensional issue space that is on the side of the hyperplane that corresponds to offers that an opponent is perceived as being likely to accept. In contrast, if application of the candidate offer to the expression for the hyperplane demonstrates that the offer falls within the region in the D-dimensional issue space that is on the side of the hyperplane that corresponds to offers that an opponent is perceived as being unlikely to accept, the automated negotiation agent 306 may determine that the candidate offer is unlikely to be accepted by an opponent.

In the event that it is determined that the candidate offer is unlikely to be accepted, the process returns to 702, where another candidate offer is accessed. In contrast, if the candidate offer is determined to be an offer that the opponent is likely to accept, at 708, the candidate offer is presented to the opponent.

A number of methods, techniques, systems, and apparatuses have been described. However, additional alternatives are contemplated. For example, while the techniques for automated negotiation described herein may generally be described in the context of an automated negotiation agent negotiating on behalf of a seller of a product or service, the techniques can be applied equally well in the context of an automated negotiation agent negotiating on behalf of a buyer of a product or service. Furthermore, while the techniques for automated negotiation described herein generally are described in the context of an automated negotiation agent engaging in a negotiation with a human counterpart, the described techniques also could be applied by an automated negotiation agent engaged in a negotiation with another automated negotiation agent. That is to say, automated negotiation agents as described herein may be opposing-party agnostic. Moreover, the techniques for automated negotiation described herein are not necessarily limited to being applied to negotiations related to the sale/purchase of a product or service. Rather, the techniques for automated negotiation described herein may be applied in many different types of negotiation settings.

As described above, according to one general aspect, multiple candidate offers, each of which specifies potential terms for a transaction that is being negotiated in a particular negotiation and that involves multiple issues, are applied to a classifier. The classifier was trained based on offers previously accepted by one or more opposing parties in previous negotiations and based on offers previously made by one or more opposing parties in one or more negotiations. In addition, the classifier represents a boundary in an issue space of the particular transaction between a first region in the issue space in which points correspond to combinations of terms that an opponent is likely to accept and a second region in the issue space in which points correspond to combinations of terms that an opponent is unlikely to accept. Based on results of having applied the candidate offers to the classifier, a subset of the candidate offers that belong to the first region in the issue space is identified. For each of multiple of the candidate offers within the subset of candidate offers identified as belonging to the first region in the issue space, a distance between the boundary in the issue space and the candidate offer in the issue space is determined. Then, based on results of determining distances between the boundary in the issue space and each of the multiple candidate offers within the subset of candidate offers identified as belonging to the first region in the issue space, a particular candidate offer is identified from among the multiple candidate offers within the subset of candidate offers identified as belonging to the first region in the issue space as a candidate offer to propose to an opponent in the particular negotiation.

Implementations may include one or more of the following features. For example, the classifier may be a support vector machine classifier. In addition, in some implementations, a distance between the boundary in the issue space and each of the candidate offers within the subset of candidate offers identified as belonging to the first region in the issue space may be determined. In such implementations, an individual one of the subset of candidate offers identified as belonging to the first region in the issue space may be identified as being closest to the boundary in the issue space relative to the other candidate offers within the subset of candidate offers identified as belonging to the first region in the issue space, and the individual candidate offer identified as being closest to the boundary in the issue space may be identified as the particular candidate offer.

Furthermore, in some implementations, the particular candidate offer may be presented to the opponent as a consequence of having identified the particular candidate offer as a candidate offer to propose to the opponent in the particular negotiation.

According to another general aspect, data is accessed that reflects offers previously accepted by one or more opposing parties in negotiations and offers previously made by one or more opposing parties in negotiations. In addition, a classifier is trained to classify candidate offers as belonging to classes that reflect different likelihoods that an opponent in a negotiation will accept the candidate offers (e.g., a first class of offers an opponent is likely to accept and a second class of offers an opponent is unlikely to accept) using the accessed data that reflects the offers previously accepted by one or more opposing parties and the offers previously made by one or more opposing parties.

Implementations may include one or more of the following features. For example, data that reflects offers previously rejected by one or more opposing parties in negotiations also may be accessed, and the classifier may be trained to classify candidate offers as belonging to classes that reflect different likelihoods that an opponent in a negotiation will accept the candidate offers using the accessed data that reflects the offers previously accepted by one or more opposing parties, the offers previously made by one or more opposing parties, and the offers previously rejected by one or more parties.

Furthermore, in some implementations, the negotiation may involve D≧2 issues, and accessing data that reflects offers previously accepted by one or more opposing parties and offers previously made by one or more opposing parties may include accessing D-element accepted offer vectors, each of which specifies a combination of terms for the D issues involved in the negotiation that was accepted by an opposing party in a previous negotiation, and accessing D-element made offer vectors, each of which specifies a combination of terms for the D issues involved in the negotiation that previously were offered by an opposing party. In addition, accessing data that reflects offers previously rejected by one or more opposing parties may include accessing D-element rejected offer vectors, each of which specifies a combination of terms for the D issues involved in the negotiation that previously was rejected by an opposing party. In such implementations, the classifier may be trained to classify candidate offers as belonging to classes that reflect different likelihoods that an opponent in a negotiation will accept the candidate offers using the accessed D-element accepted offer vectors, the accessed D-element made offer vectors, and the D-element rejected offer vectors.

Moreover, the D issues involved in the negotiation may define a D-dimensional issue space for the negotiation, and training the classifier to classify candidate offers as belonging to classes that reflect different likelihoods that an opponent in a negotiation will accept the candidate offers using the accessed D-element accepted offer vectors, the accessed D-element made offer vectors, and the D-element rejected offer vectors may include defining a boundary in the D-dimensional issue space between a first region and a second region such that points within the first region in the D-dimensional issue space correspond to combinations of terms for the D issues involved in the negotiation that an opponent is likely to accept and points within the second region in the D-dimensional issue space correspond to combinations of terms for the D issues involved in the negotiation that an opponent is likely to reject. In some implementations, defining such a boundary in the D-dimensional issue space between the first region and the second region may include deriving an expression for a hyperplane in the D-dimensional issue space such that the hyperplane splits the D-dimensional issue space into the first region and the second region. In such implementations, deriving an expression for a hyperplane in the D-dimensional issue space may include deriving an expression for a hyperplane in the D-dimensional issue space that includes a D-element normal vector, computing a first median of the accessed D-element accepted offer vectors and the accessed D-element made offer vectors, computing a second median of the D-element rejected offer vectors, and initializing values of the elements of the D-element normal vector using the computed first median and the computed second median. Additionally or alternatively, deriving an expression for a hyperplane in the D-dimensional issue space may include deriving an expression for a hyperplane in the D-dimensional space that includes a scalar; and initializing a value of the scalar using the computed first median and the computed second median, and performing a series of iterative adjustments to the values of the D-element normal vector and the scalar.

According to yet another aspect, a first set of D-element vectors that includes D-element vectors representing offers previously accepted by one or more opposing parties in previous negotiations related to a particular type of transaction and involving D≧2 issues, where the different elements of the D-element vectors in the first set of D-element vectors represent terms for the issues involved in previous negotiations related to the particular type of transaction, is accessed. Similarly, a second set of D-element vectors representing offers previously rejected by one or more opposing parties in one or more negotiations related to the particular type of transaction and involving D≧2 issues, where the different elements of the D-element vectors in the second set of D-element vectors represent terms for the issues involved in the one or more negotiations related to the particular type of transaction, also is accessed. In addition, a first median of the accessed first set of D-element vectors is computed, and a second median of the accessed second set of D-element vectors is computed. The computed first median of the accessed first set of D-element vectors and the computed second median of the accessed second set of D-element vectors then are used to initialize values of a D-element normal vector and a scalar used to define an expression for a hyperplane in a D-dimensional issue space defined by the D issues. Thereafter, a series of iterative changes to the values of the D-element normal vector and the scalar are performed to adjust the hyperplane in the D-dimensional issue space, where the adjusted hyperplane splits the D-dimensional issue space into a first region and a second region such that points in the first region correspond to offers an opposing party is perceived likely to accept and points in the second region correspond to offers an opposing party is perceived likely to reject. Then, a D-element candidate offer vector representing terms for the D issues of a candidate offer is applied to the expression for the adjusted hyperplane, and, based on a result of applying the D-element candidate offer vector to the expression for the adjusted hyperplane, it is determined that an opponent in a current negotiation is perceived likely to accept the candidate offer. As a consequence of determining that the opponent is perceived likely to accept the candidate offer, the candidate offer is caused to be presented to the opponent.

In some such implementations, the first set of accessed D-element vectors also may include D-element vectors representing offers previously made by one or more opposing parties in negotiations related to the particular type of transaction, and computing a first median of the accessed first set of D-element vectors may include computing a first median of the D-element vectors representing offers previously accepted by one or more opposing parties in previous negotiations related to the particular type of transaction and the D-element vectors representing offers previously made by one or more opposing parties in negotiations related to the particular type of transaction.

The described methods, techniques, systems, and apparatuses may be implemented in digital electronic circuitry or computer hardware, for example, by executing instructions stored in computer-readable storage media.

A process implementing techniques disclosed herein may be performed by a processor executing instructions stored on a tangible computer-readable storage medium for performing desired functions by operating on input data and generating appropriate output. Suitable processors include, by way of example, both general and special purpose microprocessors. Suitable computer-readable storage devices for storing executable instructions include all forms of non-volatile memory, including, by way of example, semiconductor memory devices, such as Erasable Programmable Read-Only Memory (EPROM), Electrically Erasable Programmable Read-Only Memory (EEPROM), and flash memory devices; magnetic disks such as fixed, floppy, and removable disks; other magnetic media including tape; and optical media such as Compact Discs (CDs) or Digital Video Disks (DVDs). Any of the foregoing may be supplemented by, or incorporated in, specially designed application-specific integrated circuits (ASICs).

Although the operations of the disclosed techniques may be described herein as being performed in a certain order and/or in certain combinations, in some implementations, individual operations may be rearranged in a different order, combined with other operations described herein, and/or eliminated, and the desired results still may be achieved. Similarly, components in the disclosed systems may be combined in a different manner and/or replaced or supplemented by other components and the desired results still may be achieved.

What is claimed is:

1. A system comprising:
one or more processing elements; and
computer memory storing instructions that, when executed by the one or more processing elements, cause the one or more processing elements to:
apply multiple candidate offers, each of which specifies potential terms for a transaction being negotiated in a particular negotiation and involving multiple issues, to a classifier, the classifier having been trained based on offers previously accepted by one or more opposing parties in previous negotiations and based on offers previously made by one or more opposing parties in one or more negotiations and the classifier representing a boundary in an issue space of the particular transaction between a first region in the issue space in which points correspond to combinations of terms that an opponent is likely to accept and a second region in the issue space in which points correspond to combinations of terms that an opponent is unlikely to accept;
based on results of having applied the candidate offers to the classifier, identify a subset of the candidate offers that belong to the first region in the issue space;
for each of multiple of the candidate offers within the subset of candidate offers identified as belonging to the first region in the issue space, determine a distance between the boundary in the issue space and the candidate offer in the issue space; and
based on results of determining distances between the boundary in the issue space and each of the multiple candidate offers within the subset of candidate offers identified as belonging to the first region in the issue space, identify a particular candidate offer from among the multiple candidate offers within the subset of candidate offers identified as belonging to the first region in the issue space as a candidate offer to propose to an opponent in the particular negotiation.

2. The system of claim 1 wherein the classifier is a support vector machine classifier such that the instructions that, when executed by one or more processing elements, cause the one or more processing elements to apply the candidate offers to a classifier include instructions that, when executed by one or more processing elements, cause the one or more processing elements to apply the candidate offers to the support vector machine classifier.

3. The system of claim 1 wherein:
the instructions that, when executed by one or more processing elements, cause the one or more processing elements to determine a distance between the boundary in the issue space and each of multiple of the candidate offers within the subset of candidate offers identified as belonging to the first region in the issue space include instructions that, when executed by one or more processing elements, cause the one or more processing elements to determine a distance between the boundary in the issue space and each of the candidate offers within the subset of candidate offers identified as belonging to the first region in the issue space; and
the instructions that, when executed by one or more processing elements, cause the one or more processing elements to identify a particular candidate offer from among the multiple candidate offers within the subset of candidate offers identified as belonging to the first region in the issue space as a candidate offer to propose to an opponent in the particular negotiation based on results of determining distances between the boundary in the issue space and each of the multiple candidate offers within the subset of candidate offers identified as belonging to the first region in the issue space include instructions that, when executed by one or more processing elements, cause the one or more processing elements to:
identify an individual one of the subset of candidate offers identified as belonging to the first region in the issue space as being closest to the boundary in the issue space relative to the other candidate offers within the subset of candidate offers identified as belonging to the first region in the issue space, and
identify the individual candidate offer identified as being closest to the boundary in the issue space as the particular candidate offer.

4. The system of claim 3 wherein the computer memory further stores instructions that, when executed by one or more processing elements, cause the one or more processing elements to present the particular candidate offer to the opponent as a consequence of having identified the particular candidate offer as a candidate offer to propose to the opponent in the particular negotiation.

5. A computer-implemented method comprising:
accessing data reflecting offers previously accepted by one or more opposing parties in negotiations and offers previously made by one or more opposing parties in negotiations;
training a classifier to classify candidate offers as belonging to classes that reflect different likelihoods that an opponent in a negotiation will accept the candidate offers using the accessed data reflecting the offers previously accepted by one or more opposing parties and the offers previously made by one or more opposing parties.

6. The method of claim 5 further comprising accessing data reflecting offers previously rejected by one or more opposing parties in negotiations, wherein training the classifier to classify candidate offers as belonging to classes that reflect different likelihoods that an opponent in a negotiation will accept the candidate offers using the accessed data reflecting the offers previously accepted by one or more opposing parties and the offers previously made by one or more opposing parties includes training the classifier to classify candidate offers as belonging to classes that reflect different likelihoods that an opponent in a negotiation will accept the candidate offers using the accessed data reflecting the offers previously accepted by one or more opposing parties, the offers previously made by one or more opposing parties, and the offers previously rejected by one or more parties.

7. The method of claim 6 wherein:
the negotiation involves D≧2 issues;
accessing data reflecting offers previously accepted by one or more opposing parties and offers previously made by one or more opposing parties includes:
accessing D-element accepted offer vectors, each of which specifies a combination of terms for the D issues involved in the negotiation that was accepted by an opposing party in a previous negotiation, and
accessing D-element made offer vectors, each of which specifies a combination of terms for the D issues involved in the negotiation that previously were offered by an opposing party;
accessing data reflecting offers previously rejected by one or more opposing parties includes accessing D-element rejected offer vectors, each of which specifies a combination of terms for the D issues involved in the negotiation that previously was rejected by an opposing party; and
training the classifier to classify candidate offers as belonging to classes that reflect different likelihoods that an opponent in a negotiation will accept the candidate offers using the accessed data reflecting the offers previously accepted by one or more opposing parties, the offers previously made by one or more opposing parties, and the offers previously rejected by one or more parties includes training the classifier to classify candidate offers as belonging to classes that reflect different likelihoods that an opponent in a negotiation will accept the candidate offers using the accessed D-element accepted offer vectors, the accessed D-element made offer vectors, and the D-element rejected offer vectors.

8. The method of claim 7 wherein:
the D issues involved in the negotiation define a D-dimensional issue space for the negotiation; and
training the classifier to classify candidate offers as belonging to classes that reflect different likelihoods that an opponent in a negotiation will accept the candidate offers using the accessed D-element accepted offer vectors, the accessed D-element made offer vectors, and the D-element rejected offer vectors includes defining a boundary in the D-dimensional issue space between a first region and a second region such that points within the first region in the D-dimensional issue space correspond to combinations of terms for the D issues involved in the negotiation that an opponent is likely to accept and points within the second region in the D-dimensional issue space correspond to combinations of terms for the D issues involved in the negotiation that an opponent is likely to reject.

9. The method of claim 8 wherein defining the boundary in the D-dimensional issue space between the first region and the second region includes deriving an expression for a hyperplane in the D-dimensional issue space such that the hyperplane splits the D-dimensional issue space into the first region and the second region.

10. The method of claim 9 wherein deriving an expression for a hyperplane in the D-dimensional issue space includes:
deriving an expression for a hyperplane in the D-dimensional issue space that includes a D-element normal vector;
computing a first median of the accessed D-element accepted offer vectors and the accessed D-element made offer vectors;
computing a second median of the D-element rejected offer vectors; and
initializing values of the elements of the D-element normal vector using the computed first median and the computed second median.

11. The method of claim 10 wherein deriving an expression for a hyperplane in the D-dimensional issue space further includes:
deriving an expression for a hyperplane in the D-dimensional space that includes a scalar; and
initializing a value of the scalar using the computed first median and the computed second median.

12. The method of claim 11 wherein deriving an expression for a hyperplane in the D-dimensional issue space further includes performing a series of iterative adjustments to the values of the D-element normal vector and the scalar.

13. The method of claim 5 wherein training the classifier to classify candidate offers as belonging to classes that reflect different likelihoods that an opponent in a negotiation will accept the candidate offers using the accessed data reflecting the offers previously accepted by one or more opposing parties and the offers previously made by one or more opposing parties includes training the classifier to classify candidate offers as belonging to one of a first class of offers an opponent is likely to accept and a second class of offers an opponent is unlikely to accept using the accessed data reflecting the offers previously accepted by one or more opposing parties and the offers previously made by one or more opposing parties.

14. A non-transitory computer-readable storage medium storing instructions that, when executed by a computer, cause the computer to:
access a first set of D-element vectors that includes D-element vectors representing offers previously accepted by one or more opposing parties in previous negotiations related to a particular type of transaction and involving D≧2 issues, where the different elements of the D-element vectors in the first set of D-element vectors represent terms for the issues involved in previous negotiations related to the particular type of transaction;
access a second set of D-element vectors representing offers previously rejected by one or more opposing parties in one or more negotiations related to the particular type of transaction and involving D≧2 issues, where the different elements of the D-element vectors in the second set of D-element vectors represent terms for the issues involved in the one or more negotiations related to the particular type of transaction;
compute a first median of the accessed first set of D-element vectors;
compute a second median of the accessed second set of D-element vectors;
use the computed first median of the accessed first set of D-element vectors and the computed second median of the accessed second set of D-element vectors to initialize values of a D-element normal vector and a scalar used to define an expression for a hyperplane in a D-dimensional issue space defined by the D issues;
perform a series of iterative changes to the values of the D-element normal vector and the scalar to adjust the hyperplane in the D-dimensional issue space, the adjusted hyperplane splitting the D-dimensional issue space into a first region and a second region such that points in the first region correspond to offers an opposing party is perceived likely to accept and points in the second region correspond to offers an opposing party is perceived likely to reject;
apply a D-element candidate offer vector representing terms for the D issues of a candidate offer to the expression for the adjusted hyperplane;
based on a result of applying the D-element candidate offer vector to the expression for the adjusted hyperplane, determine that an opponent in a current negotiation is perceived likely to accept the candidate offer; and
as a consequence of determining that the opponent is perceived likely to accept the candidate offer, cause the candidate offer to be presented to the opponent.

15. The computer-readable storage medium of claim 14 wherein:
the instructions that, when executed by a computer, cause the computer to access a first set of D-element vectors that includes D-element vectors representing offers previously accepted by one or more opposing parties in previous negotiations related to the particular type of transaction and involving D≧2 issues include instructions that, when executed by a computer, cause the computer to access a first set of D-element vectors that includes D-element vectors representing offers previously accepted by one or more opposing parties in previous negotiations related to the particular type of transaction and involving D≧2 issues and D-element vectors representing offers previously made by one or more opposing parties in negotiations related to the particular type of transaction; and
the instructions that, when executed by a computer, cause the computer to compute a first median of the accessed first set of D-element vectors include instructions that, when executed by a computer, cause the computer to compute a first median of the D-element vectors representing offers previously accepted by one or more opposing parties in previous negotiations related to the particular type of transaction and the D-element vectors representing offers previously made by one or more opposing parties in negotiations related to the particular type of transaction.
